(19) United States
(12) Patent Application Publication
(10) Pub. No.: US 2016/0241031 A1
(43) Pub. Date: Aug. 18, 2016

(54) DYNAMIC PROBABILITY-BASED POWER OUTAGE MANAGEMENT SYSTEM

(71) Applicant: NEC Laboratories America, Inc., Princeton, NJ (US)

(72) Inventors: Ali Hooshmand, Campbell, CA (US); Babak Asghari, San Jose, CA (US); Ratnesh Sharma, Fremont, CA (US)

(21) Appl. No.: 15/046,110

(22) Filed: Feb. 17, 2016

Related U.S. Application Data
(60) Provisional application No. 62/117,479, filed on Feb. 18, 2015.

(51) Int. Cl. H02J 3/00; G06F 17/18; G05B 13/04

(52) U.S. Cl. CPC H02J 3/00; G05B 13/041; G06F 17/18

(57) ABSTRACT

A method and system are provided for managing a power system having a grid portion, a load portion, a storage portion, and at least one of a renewable portion and a fuel-based portion. The method includes generating, by a scheduler responsive to an indication of an occurrence of a power outage, an outage duration prediction. The method further includes solving, by the scheduler, an economic dispatch problem using a long-term energy optimization model. The method also includes generating, by the scheduler based on an analysis of the long-term energy optimization model, an energy management directive that controls, for a time period of the outage duration prediction, the storage portion and at least one of the renewable portion and the fuel-based portion. The method additionally includes controlling, by a controller responsive to the directive, the storage portion and the at least one of the renewable portion and the fuel-based portion.

### RELATED APPLICATION INFORMATION

This application claims priority to provisional application Ser. No. 62/117,479 filed on Feb. 18, 2015, incorporated herein by reference.

### BACKGROUND

1. Technical Field

The present invention relates to power management, and more particularly to a dynamic probability-based power outage management system.

2. Description of the Related Art

Electric utility companies in less-developed countries are struggling against insufficient power generation, which leads to power quality issues such as voltage and frequency variations. To maintain the voltage and frequency within their limits, they have to experience frequent unplanned power outages at different regions every day. To deal with power outages, private-owned local energy systems are formed that include different types of loads, distributed generations (DGs) such as diesel generators and renewable energy sources (RES), and storage devices such as battery units. In these hybrid systems, DGs and storage devices could be utilized to support the load during outages, or in general anytime that their use is economically beneficial. On the other hand, some issues such as the dependency of some DGs' efficiency on their output power and the intermittent nature of most renewable sources introduce a significant uncertainty and complexity in the operation of hybrid systems. This makes the conventional unit commitment more erroneous and unreliable.

Thus, there is a need for a dynamic outage management system capable of dealing with the preceding and other operation environments.

### SUMMARY

These and other drawbacks and disadvantages of the prior art are addressed by the present principles, which are directed to a dynamic probability-based power outage management system.

According to an aspect of the present principles, a method is provided for managing a power system having a power grid portion, a load portion, an energy storage portion, and at least one of a renewable energy generation portion and a fuel-based energy generation portion. The method includes generating, by a power outage scheduler responsive to an indication of an occurrence of a power outage, an outage duration prediction for the power outage. The method further includes solving, by the power outage scheduler, an economic dispatch problem using a long-term energy optimization model. The method also includes generating, by the power outage scheduler based on an analysis of the long-term energy optimization model, an energy management directive that controls, for a time period of the outage duration prediction, the operation of the energy storage portion and at least one of the renewable energy generation portion and the fuel-based energy generation portion. The method additionally includes controlling, by a power management controller responsive to the energy management directive, the operation of the energy storage portion and the at least one of the renewable energy generation portion and the fuel-based energy generation portion.

According to another aspect of the present principles, a system is provided for managing a power system having a power grid portion, a load portion, an energy storage portion, and at least one of a renewable energy generation portion and a fuel-based energy generation portion. The system includes a power outage scheduler configured to: generate an outage duration prediction for a power outage responsive to an indication of an occurrence of the power outage; solve an economic dispatch problem using a long-term energy optimization model; and generate, based on an analysis of the long-term energy optimization model, an energy management directive that controls, for a time period of the outage duration prediction, the operation of the energy storage portion and at least one of the renewable energy generation portion and the fuel-based energy generation portion. The system further includes a power management controller for controlling, responsive to the energy management directive, the operation of the energy storage portion and the at least one of the renewable energy generation portion and the fuel-based energy generation portion.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary system 200 for dynamic probability-based power outage management, in accordance with an embodiment of the present principles;

FIG. 3 shows an exemplary power system 300 to which the present principles can be applied, in accordance with an embodiment of the present principles; and

FIGS. 4-5 show an exemplary method 400 for dynamic probability-based power outage management, in accordance with an embodiment of the present principles.

### DETAILED DESCRIPTION OF PREFERRED EMBODIMENTS

The present principles are directed to a dynamic probability-based power outage management system (also interchangeably referred to herein as “power management system”).

In an embodiment, an energy management framework is provided as a supervisory control within each local energy system. In an embodiment, the energy management framework advantageously dispatches one or more types of generated energy to minimize the operational costs of such systems while providing an uninterrupted supply of power in the presence of grid power outages, unpredictable variations of DGs, and other physical limitations.

In an embodiment, during grid-connected times, the dynamic probability-based power outage management system controls the devices in a power system by comparing their cost of operation and by considering constraints of the devices. Whenever an outage occurs, the system's long-term optimizer is triggered. Using its forecasting and optimizing capabilities, the system performs efficiently during an outage in terms of maximizing the efficiency and utilization of generated energy sources (e.g., renewable energy generation and fuel-based energy generation).

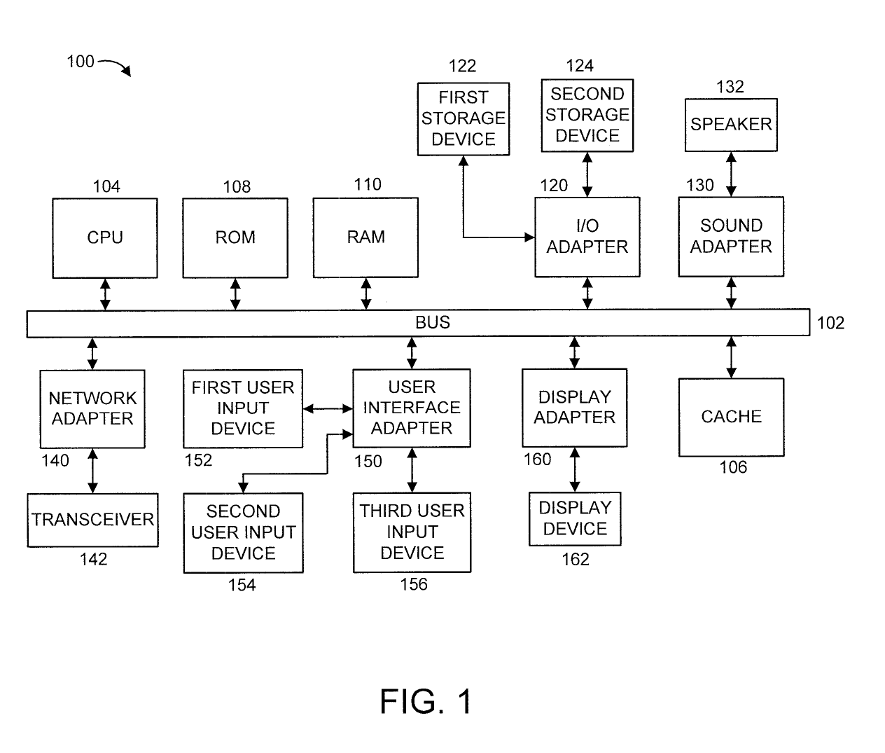

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

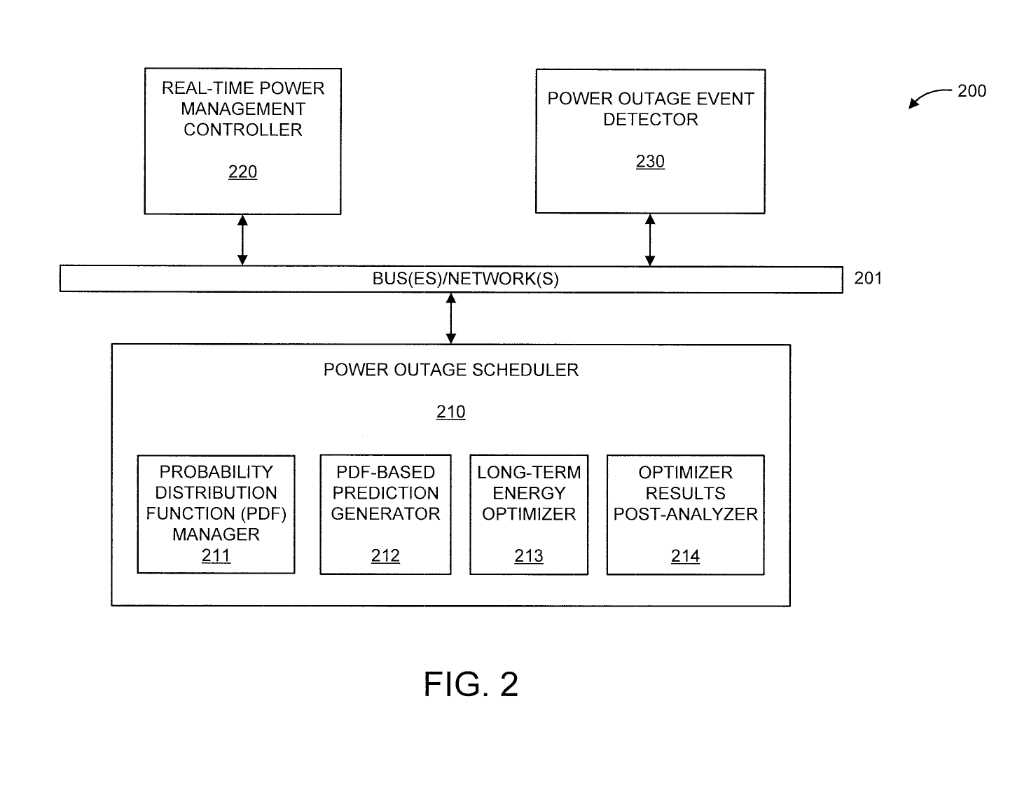

Moreover, it is to be appreciated that system 200 described below with respect to FIG. 2 is a system for implementing respective embodiments of the present principles. Part or all of processing system 100 may be implemented in one or more of the elements of system 200.

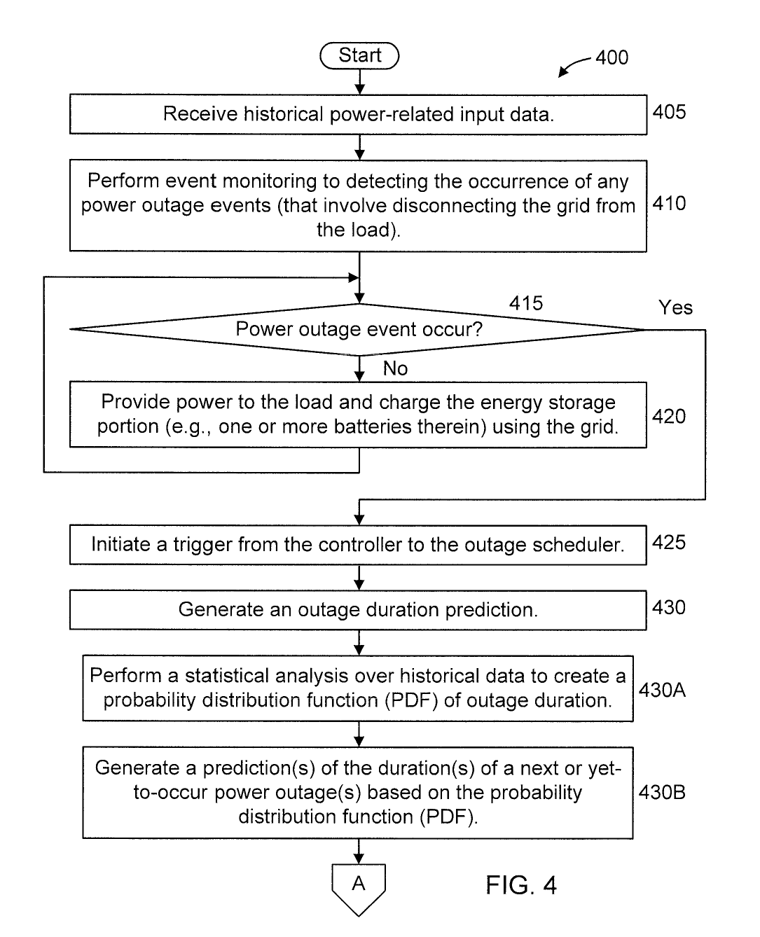

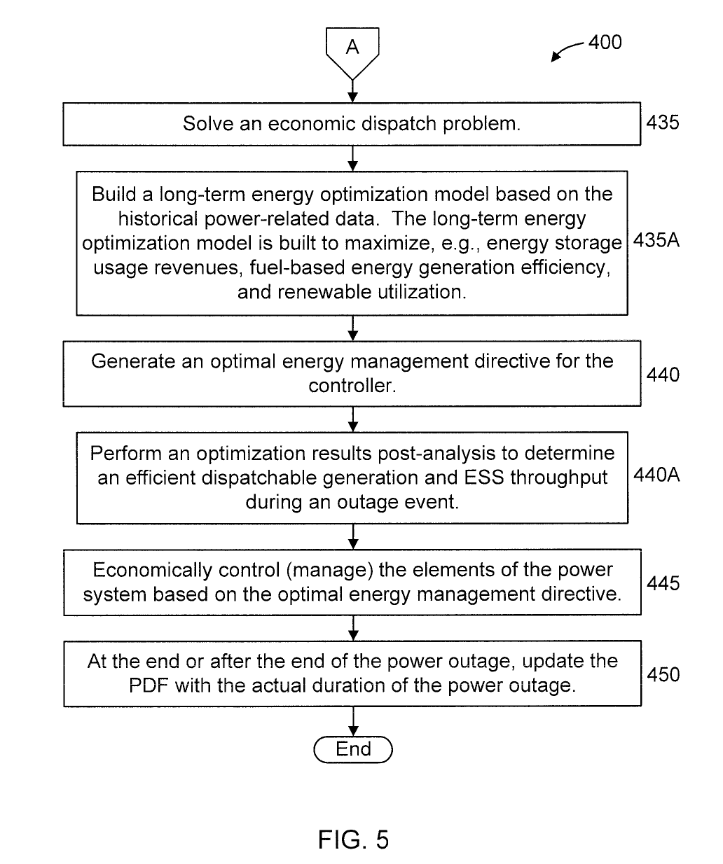

Further, it is to be appreciated that processing system 100 may perform at least part of the method described herein including, for example, at least part of method 400 of FIGS. 4-5. Similarly, part or all of system 200 may be used to perform at least part of method 400 of FIGS. 4-5.

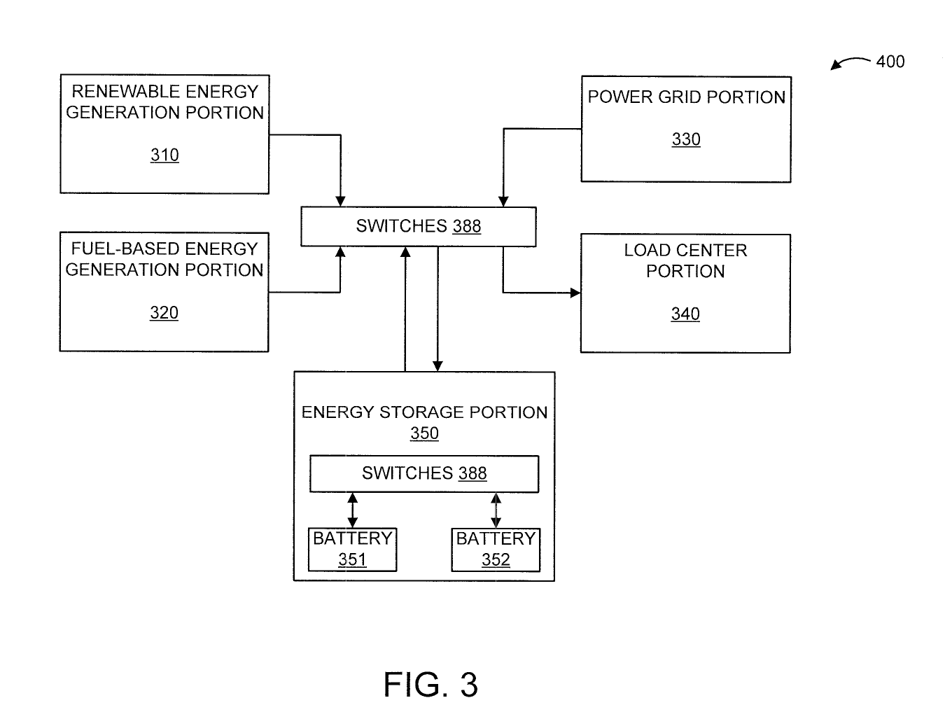

FIG. 2 shows an exemplary system 200 for dynamic probability-based power outage management, in accordance with an embodiment of the present principles. The system 200 can operate available energy sources (e.g., such as those shown in power system 300 of FIG. 3) in a way that achieves the minimum operational cost for a local energy system, and is robust and reliable so as to supply a load during random outage events without any interruption. The system 200 advantageously is able to consider the stochasticity of outage events, the efficiency characteristics of DG elements such as diesel generators, and other operational constraints.

The system 200 includes a power outage scheduler 210, a real-time power management controller 220, and a power outage event detector 230. The power outage scheduler 210 includes a probability distribution function (PDF) manager 211, a PDF-based prediction generator 212, a long-term energy optimizer 213, and an optimizer results post-analyzer 214.

As elements 211 through 214 are included in the power outage scheduler 210, their functions as described hereinafter can be specifically attributes to these devices (211 through 214) or can be generally attributed to the power outage scheduler 210.

The PDF manager 211 generates a PDF model for outage duration. Moreover, the PDF manager 211 dynamically updates the PDF model by observing actual outage durations to improve predicting/forecasting accuracy.

The PDF-based prediction generator 212 generates duration predictions (interchangeably referred to as “forecasts”) for power outage events.

The long-term energy optimizer 213 gathers measured and forecasted information such as outage duration, energy storage state of charge, renewable availability, and so forth and uses the information to solve an optimization problem to achieve the minimum operation cost for the system during an outage event.

The optimizer results post-analyzer 214 analyzes the detailed results provided by the long-term energy optimizer 213 to construct/extract messages required for efficient control of devices in real-time. The messages can include a total DG generation during an outage event, the total ESS throughput, and so forth.

The outage scheduler 210 provides directives for the power management controller 220 based on, e.g., the PDF model, the results of the optimizer results post-analyzer 214, and so forth.

The power outage event detector 230 detects a power outage event for which the long-term energy optimizer 213 (or, in general, the outage scheduler 210) is called. Such power outage events include, but are not limited to, actual power outages, power interruptions, etc. In this way, the system 200 can deal with each outage event separately. The power outage event detector 230 can detect a power outage event itself and/or can receive information from another element that indicates a power outage event has occurred.

The power management controller 220 controls various devices in a power system (e.g., power system 300) based on directives issued by the outage scheduler 210. In an embodiment, the power management controller 220 manages the devices in the power system on a real-time basis. In an embodiment, the power management controller 220 manages the elements of the power system during grid-connected time and outage times.

In the embodiment shown in FIG. 2, the elements thereof are interconnected by a bus(es)/network(s) 201. However, in other embodiments, other types of connections can also be used. Moreover, in an embodiment, at least one of the elements of system 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system 200 are readily determined by one of ordinary skill in the art, given the teachings of the present principles provided herein, while maintaining the spirit of the present principles.

FIG. 3 shows an exemplary power system 300 to which the present principles can be applied, in accordance with an embodiment of the present principles.

The power system 300 includes a renewable energy generation portion 310, a fuel-based energy generation portion 320, a power grid portion 330, a load center portion 340, and an energy storage portion 350. The term “distributed generation” (DG) can refer to any of the renewable energy generation portion 310 and/or the fuel-based energy generation portion 320. The environment 300 interfaces with system 200.

Thus, the present principles are primarily described herein with respect to the renewable energy generation portion 310, the fuel-based energy generation portion 320, and the energy storage portion 350 being possible power sources for the load in the event of a power outage event and is further described with at least one of the elements 310 and 320 also charging the energy storage portion 350 depending upon the implementation. However, in other embodiment, an energy storage portion and only one of the renewable energy generation portion 310 and the fuel-based energy generation portion 320 may be present and utilized in accordance with the teachings of the present principles, while maintaining the spirit of the present principles. Thus, reference herein to one of elements 310 and 320 can, in other embodiments, involve the other one of elements 310 and 320 and can, in yet other embodiments, involve both of elements 310 and 320.

It is to be further appreciated that references to any of portions 310, 320, and 350 can also be interchangeably made herein with respect to the elements in such portions (e.g., the terms “energy storage portion” and “battery” can be used interchangeably herein, as well as the terms “fuel-based energy generation portion” and “diesel generator” (or simply “diesel”), as well as the terms “renewable energy generation portion” and “solar/wind/water-based power generator”.

The renewable energy generation portion 310 can include, for example, but is not limited to, wind-based power generators, solar-based power generators, water-based power generators, and so forth.

The fuel-based energy generation portion 320 can include, for example, but is not limited to, generators powered by fuel (gasoline, diesel, propane, etc.), and so forth.

The power grid portion 330 provides the structure for conveying power (e.g., to local and/or remote locations). The power grid portion 330 can correspond to a grid and/or a microgrid (MG) and/or a portion(s) thereof.

The load center 340 is a consumer of the power and can be a facility, a region, and/or any entity that provides a load for the power. In an embodiment, the load center 340 is a base transceiver station (BTS). Of course, other types of load entities can also be used, while maintaining the spirit of the present principles.

The energy storage portion 350 can include one or more energy storage devices such as batteries that can be modeled in accordance with the present principles. Batteries are typically employed in a microgrid or in a power system for frequency regulation, demand response and demand charge, load shifting, and so on. As it is shown in FIG. 3, an energy storage device can either be charged or discharged in the power system.

Hardware-based switches 388 can be used to switch from one battery 351 to another battery 352 or one type of energy source to another type of energy source depending upon and responsive to any of the PDF model, forecasts made using the PDF model, results of the long-term energy optimizer 220, and/or results of the optimizer results post-analyzer 230.

The system 200 can interface with the power system 300 (as shown and described with respect to FIG. 3) in order to control the energy resources (elements) of the power system 300.

FIGS. 4-5 show an exemplary method 400 for dynamic probability-based power outage management, in accordance with an embodiment of the present principles. Some of the variables used in method 400 are described in further detail hereinafter.

At step 405, receive (e.g., collect) historical power-related input data. The historical power-related input data can include measured and/or estimated (forecasted) historical power-related data. The historical power-related data can include, but is not limited to, estimated times and durations of grid power outages, renewable generation and load forecasted profiles (e.g., for predetermined periods of times (e.g., daily)), energy storage system (ESS) capacity, dispatchable source efficiency, and so forth.

At step 410, perform event monitoring to detecting the occurrence of any power outage events (that involve disconnecting the grid from the load).

At step 415, determine whether a power outage event has occurred (that involves disconnecting the grid from the load). If not, then the method proceeds to step 420. Otherwise, the method proceeds to step 425.

At step 420, provide power to the load and charge the energy storage portion (e.g., one or more batteries therein) using the grid. In an embodiment, step 420 can involve charging the energy storage portion up to its state of charge maximum (soc^{max}).

At step 425, initiate a trigger from the controller to the outage scheduler.

At step 430, generate an outage duration prediction.

In an embodiment, step 430 includes steps 430A and 430B.

At step 430A, perform a statistical analysis over historical data to create a probability distribution function (PDF) of outage duration.

At step 430B, generate a prediction(s) of the duration(s) of a next or yet-to-occur power outage(s) based on the probability distribution function (PDF).

At step 435, solve an economic dispatch problem.

In an embodiment, step 435 includes step 435A.

At step 435A, build a long-term energy optimization model based on the historical power-related data. The long-term energy optimization model is built to maximize, e.g., energy storage usage revenues, fuel-based energy generation efficiency (e.g., diesel efficiency), and renewable (solar, wind, etc.) utilization.

At step 440, generate an optimal energy management directive for the controller. The optimal energy management directive can involve battery power, diesel energy generation, solar energy generation, wind energy generation, and so forth. The optimal energy management directive can include, for example, the optimal diesel generation E_{dies}^{opt}.

In an embodiment, step 440 includes step 440A.

At step 440A, perform an optimization results post-analysis to determine an efficient dispatchable generation and ESS throughput during an outage event.

At step 445, economically control (manage) the elements of the power system based on the optimal energy management directive. For example, one or more of the renewable energy generation portion 310 (e.g., solar, wind, etc.), the fuel-based energy generation portion 320 (e.g., a diesel generator) and the energy storage portion 350 (e.g., batteries) can be managed according to the optimal energy management directive. Since the optimal energy management directive is premised on a cost-based operation approach (using the economic dispatch problem), the cost-based operation approach operates the power generating system (e.g., system 300) in a manner that meets operational (e.g., power demand) requirements of system 300 in the most cost-efficient manner.

In an embodiment, the control of the elements of the power system 300 by the real-time power management controller 220 can involve supplying the load portion 340 using the energy storage portion (battery) 350 until soc^{min} (diesel 320 is idle), the diesel 320 supplied the load after soc^{min}, and the diesel 320 charges the energy storage portion (battery) up to E_{dies}^{opt}.

At step 450, at the end or after the end of the power outage, update the PDF with the actual duration of the power outage. In this way, the prediction accuracy based on the PDF will be improved for future predictions.

A description will now be given of an energy system model to which the present principles can be applied, in accordance with an embodiment of the present principles. However, it is to be appreciated that the present principles are not limited to solely the particular model described herein and, thus, other models and/or variations to the described model can be readily used in accordance with the teachings of the present principles, while maintaining the spirit of the present principles.

In an embodiment, the energy system is modeled as a directed graph based on the energy system of a typical base transceiver station (BTS). In such a system, battery units (as represented by the energy storage portion 350 in FIG. 3) and diesel generator (as represented by the fuel-based energy generation portion 320 in FIG. 3) are traditionally used as backup power sources to supply the BTS load whenever grid power is not available. In FIG. 3, the power grid portion 330 represents the grid connection. When it is available, the power grid portion 330 is able to both charge the battery and supply the load. The energy storage portion 350 introduces the battery set. The battery set can be charged by grid in grid-connected times, and by the diesel (fuel-based energy generation portion 320) during outage times. It can also supply the load (be discharged) during the outages or in general whenever it is economically beneficial. Battery state of charge (SOC) dynamically changes based on the following difference equation:

soc(t+1)=soc(t)−αP_{batt}(t) (1)

where soc(t) is battery SoC in ampere-hour (Ah) at time t, α is a coefficient that changes kW unit into Ah, and also includes a sampling time term, P_{batt}(t) is the battery output power at time t. A negative value for P_{batt}(t) means the battery is charged, and a positive value means that power is discharging from the battery. The battery SOC could vary in the allowable operational range recommended by battery manufacturer. This constraint is expressed as follows:

soc^{min}≦soc(t)≦soc^{max} (2)

where soc^{min} is minimum SOC or maximum depth of discharge (DOD), and soc^{max} is maximum SOC or minimum DOD, depth of discharge. Similarly, battery power is also restricted by its rated power, P_{batt}^{max}, as follows:

|P_{batt}(t)|≦P_{batt}^{max} (3)

The fuel-based energy generation portion 320 in FIG. 3 can represent the diesel generator. The operation of the diesel generator is affected by its efficiency characteristic. For higher values of power, a diesel asset consumes less fuel per kWh of generation. It means that the diesel price is cheaper for higher levels of generation, as follows:

diesel price[$/kWh]∝1/P_{dies} (4)

In addition, diesel output power (P_{dies}(t)[kW]) is bounded by its rated power as follows:

0≦P_{dies}(t)≦p_{diesel}^{max} (5)

Finally, the load portion 340 in FIG. 3 is the energy system load. Total power provided by energy sources (grid, battery and diesel) should balance the system load, L(t), at each time instance, as follows:

P_{grid}(t)+P_{dies}(t)+P_{renewable}(t)+P_{batt}(t)=L(t)

A further description will now be given of the structure of a dynamic probability-based power outage management system such as system 200, in accordance with an embodiment of the present principles.

In an embodiment, the system is intended to provide: (1) efficient and economic operation of the devices; (2) uninterrupted supply to the load during both grid connected and outage times; and (3) implementation of minute-by-minute control.

In an embodiment, a tiered structure is used for the system in order to address these targets. This structure includes the real-time power management controller 220 and power outage scheduler 210.

As it can be inferred from its name, the real-time power management controller 220 operates the devices of the power system 300 on a minute-by-minute or similar basis in real-time. When the system 300 is connected to the power network, the power grid portion 330 has the priority to supply the load portion 340 since its tariff rate is cheaper than diesel generator (fuel-based energy generation portion 320) fuel cost. It also charges the battery unit 350 if it is not fully charged. When the outage occurs, there are two or three sources (depending upon the implementation) to supply the load, namely the energy storage portion (e.g., battery set) 350, the fuel-based energy generation portion (e.g., diesel generator) 320 and the renewable energy generation portion (e.g., solar, wind, water, etc.) 310. In order to economically manage these sources and maximize the diesel efficiency, the real-time power management controller 220 triggers the outage scheduler 210. Using its forecasting tool, the power outage scheduler 210 first predicts the occurred outage duration (it is a deterministic input in the case of planned outages). For the predicted time window, the power outage scheduler 210 solves an economic dispatch problem in which the objective is diesel fuel cost minimization. Based on optimal solution for dispatch problem, the power outage scheduler 210 calculates the level of diesel generation during outage event, and passes this value as long term optimal directive to the real-time power management controller 220. Using the outage scheduler optimal directive, the real-time power management controller 220 economically manages diesel generator and battery unit to supply the load during a power outage event.

A further description will now be given of the power outage scheduler (e.g., power outage scheduler 210 in FIG. 2) in accordance with an embodiment of the present principles.

To optimize energy system performance, the system 200 attempts to minimize the total energy cost in the presence of outage events. This is a straightforward task for the real-time power management controller 220 during grid-connected times since the renewable generation's operation cost is zero and grid portion 330 is the next cheapest power source. However, to achieve this goal during outage times, battery and diesel and renewable energies should be operated in a way that maximizes the diesel efficiency. To this purpose, an economic dispatch (ED) problem is formed by outage scheduler for outage time window. The objective of ED problem is minimizing the diesel operational cost during the occurred outage as follows (noting that the battery operation cost equals to zero since the charging cost is already included in diesel power costs.):

$$j := {\sum }_{t = 0}^{T} {C}_{dies} ( {P}_{dies} ( t ) , {U}_{dies} ( t ) ) \qquad ( 7 )$$

where C_{dies}(.) is diesel operational cost that is a function of its output power (P_{dies}(t)) and its commitment (U_{dies}(t)) at time t. Also, T is outage time duration. For planned outages, this value is known through local utility company. For unplanned outages, T is an uncertain parameter. To determine the value of T, the outage scheduler 210 performs a statistical analysis on historical outage data and creates the histogram for outage duration frequency. Based on an outage histogram, the outage scheduler 210 selects the value of T so that an outage duration with highest number of historical occurrences has the highest chance to be chosen. Note that the outage histogram is dynamically updated as the system 200 experiences more outage events. The constraints for ED problem are devices' operational limitations introduced in Equations (1)-(6). To handle the constraints (1) and (2), ED problem also measures battery SOC at the start of outage (extent of charging from grid before outage event). The ED optimization problem is summarized as follows:

$$min j := {\sum }_{t = 0}^{T} {C}_{dies} ( {P}_{dies} ( t ) , {U}_{dies} ( t ) )$$

$$subject to \text{:}$$

$$soc ( t + 1 ) = soc ( t ) - α {P}_{batt} ( t )$$

$${soc}^{min} \leq soc ( t ) \leq {soc}^{max}$$

$$\vert {P}_{batt} ( t ) \vert \leq {P}_{batt}^{max}$$

$$0 \leq {P}_{dies} ( t ) \leq {P}_{diesel}^{max}$$

$${P}_{grid} ( t ) + {P}_{dies} ( t ) + {P}_{renewable} ( t ) + {P}_{batt} ( t ) = L ( t )$$

The solution of ED problem (P*_{ED}, in matrix (8)) determines the optimal schedule of the battery (P*_{batt}) and the diesel generator (P*_{dies},U*_{dies}) during forecasted outage time horizon, T, as follows:

$${P}_{ED}^{*} = ( \begin{matrix}{P}_{batt}^{*} ( 1 ) & {P}_{batt}^{*} ( 2 ) & {P}_{batt}^{*} ( T ) \\ {P}_{dies}^{*} ( 1 ) & {P}_{dies}^{*} ( 2 ) & {P}_{dies}^{*} ( T ) \\ {U}_{dies}^{*} ( 1 ) & {U}_{dies}^{*} ( 2 ) & {U}_{dies}^{*} ( T )\end{matrix} ) \qquad ( 8 )$$

A further description will now be given of an optimal energy management directive issued from the power outage scheduler in accordance with an embodiment of the present principles.

Due to the possible forecasting error in outage duration prediction, the implementation of this schedule in the real time of operation may not always be feasible and could threaten system reliability. Hence, in order to maximize the performance optimality and guarantee the real time operation reliability, this schedule is analyzed by system 200 and its important information is passed to the real-time power management controller 320 as an optimal directive.

Analyzing the economic dispatch results shows that outage scheduler charges the battery by diesel power whenever diesel has to be used to supply the load. Doing this increases the diesel output power to increase its efficiency (reducing its operation cost). In addition, the battery is charged to a level that it could be completely discharged by the end of outage event. It means outage scheduler does not keep any expensive diesel power in the battery at the end of outage to minimize system operation cost.

To transfer the optimal behavior of outage scheduler to real time controller, total generation of diesel generator (E_{dies}^{opt}) during outage is calculated based on ED optimal result, P*_{ED}, as follows:

E_{dies}^{opt}=Σₜ₌₀^{T}P_{dies}(t)Δt (9)

where Δt is the sampling time. Optimal diesel generation (E_{dies}^{opt}) is passed to real-time controller as outage scheduler optimal directive. Using this information, real-time controller can achieve the same optimality in performance as outage scheduler if predicted outage duration is the same as occurred outage duration in real time.

A further description will now be given of the power management controller (e.g., the real-time power management controller 220 in FIG. 2), in accordance with an embodiment of the present principles.

The real-time power management controller 220 manages the devices in real time of operation (in a minute-by-minute basis) during grid connected and outage times. In an embodiment, to reliably and economically operating the system, it uses the following algorithm:

Gird is Connected:

The grid 330 supplies the net load (mismatch between renewable generation and load) 340 and charges the battery 350 (up to its soc^{max}) if renewable generation charge is not enough.

Gird is NOT Connected (Outage Occurred):

First, the real-time power management controller 220 triggers the outage opt scheduler 210 to prepare the optimal diesel generation (E_{dies}^{opt}). The controller 220 also starts supporting the net load 340 using by battery 350 until the battery 350 reaches soc^{min} (diesel is idle). When the battery 350 is fully discharged, the diesel generator 320 starts supplying the net load 340 and fully charging the battery 350 or until the diesel opt generator 310 reaches (E_{dies}^{opt}). By then, the diesel generator 310 is stopped and the battery 350 is discharged to supply the net load 340. When the diesel generator 320 reaches (E_{dies}^{opt}) and the controller 220 still needs to utilize the diesel generator 320 due to outage duration prediction error, the diesel generator 320 does not fully charge the battery 350 and the battery 350 is discharged anytime that is has some power to support the net load 340.

When Outage is Finished:

The real-time power management controller 220 measures the occurred outage duration. The outage database is updated based on measured value. The outage duration PDF is updated accordingly to improve future predictions.

The present principles advantageously provide a lower electricity cost for energy systems since maximizing the revenues from energy storage usage, maximizing diesel efficiency, and maximizing renewable utilization are built-in features of the proposed controller. Also, the present principles provide a reliable and robust real-time control capability of the electricity flow in a power system, which results in a cost-effective response to contingencies such as grid power outages, changes in weather condition, and load variations. Lastly, the present principles are compatible with different electricity tariffs which result in plug-and-play feature and minimizes the installation cost.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of” for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for managing a power system having a power grid portion, a load portion, an energy storage portion, and at least one of a renewable energy generation portion and a fuel-based energy generation portion, the method comprising:
generating, by a power outage scheduler responsive to an indication of an occurrence of a power outage, an outage duration prediction for the power outage;
solving, by the power outage scheduler, an economic dispatch problem using a long-term energy optimization model;
generating, by the power outage scheduler based on an analysis of the long-term energy optimization model, an energy management directive that controls, for a time period of the outage duration prediction, the operation of the energy storage portion and at least one of the renewable energy generation portion and the fuel-based energy generation portion; and
controlling, by a power management controller responsive to the energy management directive, the operation of the energy storage portion and the at least one of the renewable energy generation portion and the fuel-based energy generation portion.

2. The method of claim 1, wherein the outage duration prediction is generated by performing a statistical analysis over historical power related data to create a probability distribution function of outage duration, and generating the outage duration prediction based on the probability distribution function.

3. The method of claim 1, wherein the long-term energy optimization model is generated based on the historical power-related data.

4. The method of claim 1, wherein the long-term energy optimization model is generated so as to maximize energy storage portion usage revenues, fuel-based energy generation efficiency, and renewable energy utilization of the power system.

5. The method of claim 1, wherein the energy management directive is generated by performing an optimization results post-analysis on the long-term energy optimization model to determine an efficient allocation of resources and a throughput for the energy storage portion during the power outage.

6. The method of claim 1, wherein the energy management directive comprises utilizing at least the energy storage portion to meet power system demands and switching to the at least one of the renewable energy generation portion and the fuel-based energy generation portion when a capacity of the energy storage portion is below a threshold capacity.

7. The method of claim 6, wherein the energy management directive further comprises charging the energy storage portion using a portion of the energy provided by the renewable energy generation portion and the fuel-based energy generation portion.

8. The method of claim 1, wherein the power outage results in the power grid portion being disconnected from the load portion, and wherein the energy management directive comprises supplying power to the load portion using the grid portion at times other than during the power outage, and supplying power to the load portion using at least one of the renewable energy generation portion and the fuel-based energy generation portion during the power outage.

9. The method of claim 8, wherein the energy management directive further comprises charging the energy storage portion using the grid portion at the times other than during the power outage, and charging the energy storage portion using at least one of the renewable energy generation portion and the fuel-based energy generation portion during the power outage.

10. The method of claim 1, wherein the energy management directive comprises increasing an output of the fuel-based energy generation portion to increase an operational efficiency of the fuel-based energy generation portion.

11. The method of claim 1, wherein the energy management directive comprises utilizing the energy storage portion so as to exhaust a capacity of the energy storage portion by an end of the power outage when the energy storage portion is charged during the power outage by the at least one of the renewable energy generation portion and the fuel-based energy generation portion.

12. A non-transitory article of manufacture tangibly embodying a computer readable program which when executed causes a computer to perform the steps of claim 1.

13. A system for managing a power system having a power grid portion, a load portion, an energy storage portion, and at least one of a renewable energy generation portion and a fuel-based energy generation portion, the system comprising:
a power outage scheduler configured to:
generate an outage duration prediction for a power outage responsive to an indication of an occurrence of the power outage,
solve an economic dispatch problem using a long-term energy optimization model,
generate, based on an analysis of the long-term energy optimization model, an energy management directive that controls, for a time period of the outage duration prediction, the operation of the energy storage portion and at least one of the renewable energy generation portion and the fuel-based energy generation portion; and
a power management controller for controlling, responsive to the energy management directive, the operation of the energy storage portion and the at least one of the renewable energy generation portion and the fuel-based energy generation portion.

14. The system of claim 13, wherein the outage duration prediction is generated by performing a statistical analysis over historical power related data to create a probability distribution function of outage duration, and generating the outage duration prediction based on the probability distribution function.

15. The system of claim 13, wherein the long-term energy optimization model is generated based on the historical power-related data.

16. The system of claim 13, wherein the long-term energy optimization model is generated so as to maximize energy storage portion usage revenues, fuel-based energy generation efficiency, and renewable energy utilization of the power system.

17. The system of claim 13, wherein the energy management directive is generated by performing an optimization results post-analysis on the long-term energy optimization model to determine an efficient allocation of resources and a throughput for the energy storage portion during the power outage.

18. The system of claim 13, wherein the energy management directive comprises utilizing at least the energy storage portion to meet power system demands and switching to the at least one of the renewable energy generation portion and the fuel-based energy generation portion when a capacity of the energy storage portion is below a threshold capacity.

19. The system of claim 18, wherein the energy management directive further comprises charging the energy storage portion using a portion of the energy provided by the renewable energy generation portion and the fuel-based energy generation portion.

20. The system of claim 13, wherein the power outage results in the power grid portion being disconnected from the load portion, and wherein the energy management directive comprises supplying power to the load portion using the grid portion at times other than during the power outage, and supplying power to the load portion using at least one of the renewable energy generation portion and the fuel-based energy generation portion during the power outage.
